(19) United States
(12) Patent Application Publication
(10) Pub. No.: US 2025/0298374 A1
(43) Pub. Date: Sep. 25, 2025

(54) DEVICE FOR COMBINING BEAMS AND SYSTEM HAVING A DEVICE FOR COMBINING BEAMS AND A WHITE IMAGE HOLOGRAM

(71) Applicant: Carl Zeiss Jena GmbH, Jena (DE)

(72) Inventors: Siemen KÜHL, Jena (DE); Andre HACKE, Greiz (DE)

(73) Assignee: Carl Zeiss Jena GmbH, Jena (DE)

(21) Appl. No.: 19/077,798

(22) Filed: Mar. 12, 2025

(30) Foreign Application Priority Data
Mar. 20, 2024 (DE) 102024107999.1

(51) Int. Cl. G03H 1/24; G02B 5/32

(52) U.S. Cl. CPC G03H 1/24; G02B 5/32; G03H 2222/18; G03H 2222/31; G03H 2222/34; G03H 2223/18; G03H 2223/23

(57) ABSTRACT

A device for combining light beams with a holographic element is provided. Moreover, systems are provided in which a device for combining beams is used to illuminate a white image hologram.

### RELATED APPLICATIONS

This application claims the benefit of German patent application No. 102024107999.1 filed Mar. 20, 2024, which is incorporated by reference herein in its entirety and hereby expressly made a part of this specification.

### FIELD OF THE INVENTION

The present application relates to devices for combining beams and systems in which a device for combining beams is used for illuminating a white image hologram.

### BACKGROUND OF THE INVENTION

What are known as RGB light-emitting diodes (LEDs) or white light-emitting diodes are usually used in the reconstruction of white image holograms. For example, such systems are described in German patent applications DE 10 2023 103 962.8 and DE 10 2022 202 041.3. In this context, a white image hologram is a hologram in which the image created may appear in substantially any desired colour, including white colour, from a colour space (e.g. RGB colour space). Such a hologram is usually created by implementing separate exposures with red, green and blue light, and the illumination for reconstruction is also implemented with red, green and blue light. The desired colours, including white, arise by mixing red, green and blue light.

RGB LEDs comprise three emitters (for example for red, green and blue light) that are spaced apart from one another. This arrangement is disadvantageous in that it is difficult to convert the light emitted by the individual emitters of the LED into identical wavefronts, e.g. plane waves, using optics units with a simple design, for example using a single light-shaping or collimating, refractive or reflective optical element. As a consequence, white image holograms, consisting of multiplexed RGB gratings, are reconstructed with different levels of quality for the three colours. Multiplexed RGB gratings mean that the white image hologram was created by exposure with three wavefronts that differ only in wavelength, for example with red, green or blue light. This is particularly critical for holographic images in which the image is created at a relatively large distance from the hologram because the resulting different reconstruction angles for the three colours may cause the red, green, and blue images to diverge. This means that the three images are not precisely and completely overlaid on one another, and an image with colour fringes is created rather than a white image or an image in the desired colour.

White LEDs, by contrast, have only one emitter that emits a white spectrum. This is usually achieved by converting light from a blue light-emitting diode into white light by using a material such as a phosphor-based material. This white light is very broadband, resulting in the disadvantage that a large proportion of the light is not diffracted by the white image hologram, since the latter, for example in the case of the aforementioned RGB grating, is sensitive only around specific red, blue and green wavelengths. Furthermore, the system is much more susceptible to ghosting in this case because there are many wavelengths present for which the hologram is efficient to a certain extent, for example on account of system tolerances. Furthermore, the colour point (target white point) can only be set by way of the hologram efficiencies for the wavelengths when white LEDs are used. By contrast, this colour point can be adjusted in RGB LEDs by setting the current supply for the three emitters, by virtue of the luminous flux for the three primary colours red, green and blue being able to be adjusted separately in this way. This disadvantage may entail a significant outlay in the exposure process since the hologram must then be adapted to the white light-emitting diode and its exact spectrum in terms of the colour point already during the exposure process for the hologram.

### SUMMARY OF THE INVENTION

Aspects of the present invention provide an option for combining red, green and blue light efficiently into a common wavefront, which can then for example be used for the reconstruction of holograms. Advantageously, systems incorporating aspects of the present invention mitigate some or all of the aforementioned disadvantages in the reconstruction of white image holograms.

According to a first aspect, provision is made for a device for combining beams that comprises a holographic element. The holographic element is configured to diffract a first light beam, which is from a first wavelength range and is incident on the holographic element from a first direction, and a second light beam, which is from a second wavelength range that differs from the first wavelength range and is incident on the holographic element from a second direction that differs from the first direction, into a common third direction, which differs from the first direction and the second direction.

The first light beam from the first wavelength range and the second light beam from the second wavelength range can thereby be combined in order to form a common light beam in the third direction.

In this context, the holographic element may comprise a holographic film, i.e. a film with a photosensitive material, into which an appropriate grating is exposed for each wavelength range (i.e. for the first wavelength range and the second wavelength range, and optionally for the third wavelength range described hereinafter). This may also be an element with multiple holographic films, each of which has only one grating for a wavelength range exposed and all of which are integrated into a composite. Instead of films as carriers for photosensitive material, use may also be made of other types of arrangements and layers of photosensitive material, in which the appropriate gratings are exposed.

In this context, the diffraction may in particular be such that the first light beam and the second light beam are overlaid on one another and have a common axis, thus forming a common wavefront.

The holographic element may be configured to diffract the first light beam and the second light beam into the third direction starting from a first side of the holographic element. In that case, the holographic element may be furthermore configured to pass through the holographic element a third light beam, which is from a third wavelength range that differs from the first and second wavelength ranges and is incident on a second side of the holographic element opposite the first side of the holographic element in the third direction. In other words, the diffracted first light beam and the diffracted second light beam are radiated in the third direction on the first side of the holographic element, wherein this may occur in reflection or in transmission as explained hereinafter, i.e. the first and second light beam, prior to experiencing diffraction, may be incident on the holographic element from the first side (reflection) or the second side (transmission). The third light beam passes substantially undiffracted through the holographic element in the third direction from the second side to the first side, and it is thus combined with the diffracted first light beam and the diffracted second light beam.

This means that the aforementioned gratings are not sensitive to the third light beam that travels in the third direction, and this may be achieved by a suitable choice of the first direction and the second direction: In principle, for the corresponding direction, the exposed gratings are only sensitive to the wavelength range with which they were exposed. Such a grating typically consists of several Bragg planes that are aligned in accordance with the first direction or second direction. The directions must then be chosen substantially such that the spacing of the planes in the third direction does not “accidentally” match the third wavelength range. This then ensures that light from the third wavelength range passes through the hologram in the third direction. Thus, these Bragg planes are chosen in such a way in that case that they do not efficiently diffract light from the third wavelength range out of the third direction, i.e. they substantially do not deflect this light.

In an alternative to that, the holographic element may be furthermore configured to diffract into the common third direction a third light beam, which is from a third wavelength range that differs from the first and second wavelength ranges and is incident on the holographic element from a fourth direction that differs from the first, second and third directions. In this case, the holographic element thus also contains a grating for the third wavelength range, either multiplexed in the same film or in a separate film, as explained above.

In any case, three different wavelength ranges may be combined to form a common beam. Advantageously, the first, second and third wavelength ranges comprise a red wavelength range, a green wavelength range and a blue wavelength range (wherein the order may be as desired, i.e. the red, green and blue wavelength ranges may be the first, second and third wavelength ranges in any order). Thus, a common light beam may then be created by three appropriate light sources, for example a red, a green and a blue light-emitting diode, by means of which, for example, the white image holograms explained at the outset may be reconstructed; this will be described hereinafter. In the process, substantially any colour within the RGB colour space may be created by setting the intensities of the wavelengths. In this case, a larger colour space in comparison with other means for combining beams can be created by using a holographic element since the holographic element simultaneously serves as a wavelength filter and hence the resulting colour point of the red, green and blue wavelength ranges corresponds to a greater colour saturation (also purity) because said colour point is located on or very close to the spectral colour line determined by the holographic element. In other words, the wavelength filter property narrows the otherwise broader spectral range of the light beams created by e.g. corresponding light-emitting diodes. In comparison with light from the light-emitting diodes, the spectrum of diffracted light beams is closer to a desired spectral line, resulting in the possibility of creating a larger colour space.

In this context, the third wavelength range may be the green wavelength range, especially in the case in which the third light beam is passed through the holographic element. This is advantageous in that the efficiency for the third light beam is higher in such a configuration as diffraction losses occur for the first light beam and the second light beam. Red, green and blue light with an intensity ratio of approx. 10:35:1 is required for a photometric weighting that corresponds to the sensitivity of the eye, and so green light requires the highest intensity. Therefore, it is advantageous for green light to experience the fewest losses due to the device for combining beams.

Moreover, the holographic element may be configured to collimate the first light beam and/or the second light beam. In the case in which the third light beam is also diffracted by the holographic element, the holographic element may additionally be configured to collimate the third light beam as well. For example, this means that a spherical wave is converted into a plane wave. This eliminates the need for a separate optics unit for collimating the respective light beam.

Such a collimating function can be exposed into a corresponding holographic element by virtue of making a spherical wave as reference wave interfere with a plane wave as object wave.

In the above-described first aspect, the diffraction of the first, second and optionally third light beams may in each case be implemented in transmission or reflection, i.e. the hologram may in each case be embodied accordingly as a transmission hologram or reflection hologram. This embodiment is in turn specified by the exposure of the corresponding holographic film: A reflection hologram is formed if object beam and reference beam are incident from the same side during the exposure, and a transmission hologram is formed in the event of an incidence from different sides.

According to a further exemplary embodiment, provision is made of a system comprising
a white image hologram,
a first light source configured to emit a first light beam in a red wavelength range,
a second light source configured to emit a second light beam in a green wavelength range,
a third light source configured to emit a third light beam in a blue wavelength range, and
a device for combining beams, which is configured to combine the first light beam, the second light beam and the third light beam to form a common illumination light beam for the white image hologram.

By using a device for combining beams, it is possible to create a suitable illumination light beam with three separate light sources in a comparatively simple manner. The device for combining beams may in particular be a device for combining beams as defined hereinbefore, i.e. by means of the holographic element explained hereinbefore.

In another variant, the device for combining beams comprises an RGB prism with two dichroic mirrors. Such an RGB prism with two dichroic mirrors is sometimes also referred to as an X-cube. In this case, two of the mirrors are used to deflect two of the light beams, for example the first and the third light beam, onto the common illumination light beam and pass another light beam, for example the third light beam, in order thus to combine the beams.

In a further variant, the device for combining beams comprises a first beam splitter configured to combine two light beams from the group consisting of the first light beam, the second light beam and the third light beam in order to form an intermediate light beam, and a second beam splitter configured to combine the intermediate light beam and the remaining light beam from the group consisting of the first light beam, the second light beam and the third light beam in order to form the illumination light beam.

For example, such a beam splitter may comprise a semi-transparent mirror.

In particular, the remaining light beam may be the second light beam, i.e. the light beam in the green wavelength range. Similar to what was explained above for the holographic element, this results in the second beam having the fewest losses, as it passes only through the second beam splitter and not the first beam splitter.

The device for combining beams may be configured to polarize the illumination light beam. This may be advantageous for some types of white image holograms that are more efficient for polarized light, for example s-polarized light. For example, what are known as edge-lit holograms diffract s-polarized light much more efficiently than p-polarized light on account of the in part very flat reconstruction angle; for example, the efficiency is approximately double at an angle of incidence of 70 degrees and for example approx. fourfold at an angle of incidence of 80 degrees. Any conventional polarizers may be used for polarization, for example polarization filters such as dichroic polarization filters that are placed in the beam path.

Another option consists in the use of polarizing mirrors in the aforementioned beam splitters or the aforementioned RGB prism.

### BRIEF DESCRIPTION OF THE DRAWINGS

Exemplary embodiments are explained in detail hereinafter with reference to the accompanying drawings. In the figures:

FIG. 1 shows a device for combining beams according to one exemplary embodiment,

FIG. 2 shows a device for combining beams according to a further exemplary embodiment,

FIG. 3 shows a device for combining beams according to a further exemplary embodiment,

FIG. 4 shows a device for combining beams according to a further exemplary embodiment,

FIG. 5 shows a block diagram of a system according to one exemplary embodiment,

FIG. 6 shows a diagram of a system according to a further exemplary embodiment,

FIG. 7 shows a diagram of a system according to a further exemplary embodiment, and

FIG. 8 shows a diagram of a system according to a further exemplary embodiment.

### DETAILED DESCRIPTION OF THE INVENTION

Various exemplary embodiments are explained in detail hereinafter. These serve illustrative purposes only. Details, variations and modifications that have been described for one of the exemplary embodiments are also applicable to other exemplary embodiments and are therefore not explained again.

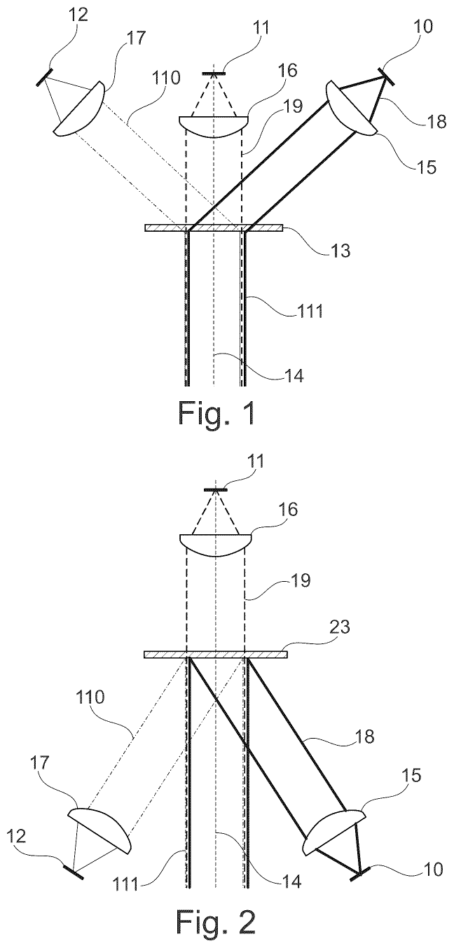

FIG. 1 shows a diagram of a device for combining beams according to a first exemplary embodiment. In the exemplary embodiment of FIG. 1, the device for combining beams is implemented by a holographic element 13.

To illustrate the functionality of the holographic element 13, a first light source 10, which emits a first light beam 18 in a first wavelength range, in a red wavelength range in this case, a second light source 11, which emits in a second light beam 19 in a second wavelength range, in a green wavelength range in this case, and a third light source 12, which emits a third light beam 110 in a third wavelength range, for example in a blue wavelength range, are shown. For example, the light sources 10, 11 and 12 may be realized by means of light-emitting diodes. To an approximation, the light sources 10, 11 and 12 may be considered to be point light sources (even though they have a certain extent) that emit an approximately spherical wave. In the exemplary embodiment of FIG. 1, optics units 15, 16 and 17 are arranged upstream of the light sources 10, 11 and 12 in order to collimate the respective emitted light beams 18, 19 and 110 respectively. While optics units 15, 16 and 17 are represented as single lenses, other optics units, e.g. having multiple lenses or having reflective elements such as parabolic mirrors, may also be used for collimation.

The first light beam 18 emitted by the first light source 10 is incident on the holographic element 13 at a first angle and is diffracted in the direction 14. The third light beam 110 emitted by the third light source 12 is incident on the holographic element 13 at a second angle that differs from the first angle and is also diffracted in the direction 14, and so these two light beams are combined. While the angles in FIG. 1 are shown as symmetrical with respect to a centre axis, this is not to be construed as limiting, and different angles in space may also be used.

The second light beam 19 emitted by the second light source 11 already travels in the direction 14 and remains substantially unaffected by the holographic element 13 and passes through the latter. Hence, the first light beam 18, the second light beam 19 and the third light beam 110 are combined to form an illumination light beam 111 in the direction 14.

In order to provide such a holographic element 13, appropriate gratings are exposed for the first light beam 18 from the first light source 10 and the third light beam 110 from the third light source 12. This may be implemented in separate holographic layers, such as holographic films, or in a common holographic film. For example, in order to create the diffraction function of the first light beam 18 emitted by the first light source 10, collimated light from the direction in which the first light source 10 is subsequently arranged during use, as reference light beam, and collimated light from the direction into which the diffraction should be implemented, i.e. from direction 14, as object light beam, are made to interfere. The same applies to the third light beam 110, which is emitted by the third light source 12. This results in respective Bragg layers, which ensure the appropriate diffraction. In the process, the angles at which the first light beam 18 and the second light beam 19 are incident on the holographic element 13 are chosen such that the spacing of the Bragg layers from the direction of the second light source 11 does not match the wavelength range of the second light source 11 (i.e. a green wavelength range in this case), and so the light from the second light source 11 passes through the holographic element.

The holographic element 13 takes the form of a transmission hologram, i.e. the first light beam 18 and the third light beam 110 pass through the holographic element 13 during the diffraction, as illustrated, and so the illumination light beam 111 is formed on the opposite side of the hologram to the illumination by the first and third light beams 110. However, an embodiment as a reflection hologram is also possible. A corresponding exemplary embodiment of a holographic element 23 is shown in FIG. 2. Apart from the embodiment as a reflection hologram, the exemplary embodiment of FIG. 2 corresponds to that of FIG. 1. It should be observed that mixed forms are also possible in principle, and so the first light beam 18 from the first light source 10 is for example diffracted in transmission and the third light beam 110 from the third light source 12 is diffracted in reflection. In the holographic element 23, the second light beam 19, which is emitted by the second light source 11, also passes through the holographic element 23.

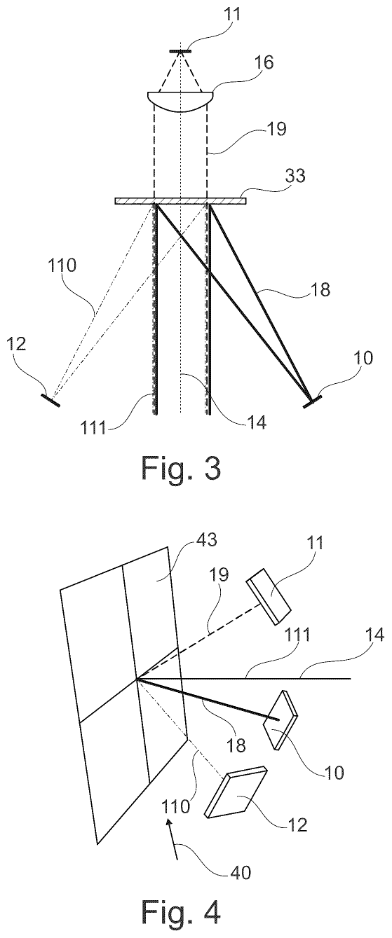

In the exemplary embodiments of FIGS. 1 and 2, the optics units 15 and 17 are used to collimate the first light beam 18 from the first light source 10 and the third light beam 110 from the third light source 12, respectively. In other exemplary embodiments, this function may be adopted by the holographic element. FIG. 3 shows a corresponding exemplary embodiment with a holographic element 33. In this context, the holographic element 33 takes the form of a reflection hologram like the holographic element 23 of FIG. 2. In comparison with FIG. 2, the optics units 15 and 17 are omitted, and so, to an approximation, the holographic element 33 is illuminated by a spherical wave from the first light source 10 and the third light source 12. The holographic element 33 diffracts the light beams 18, 110 and converts them into corresponding plane waves. Such a function can be achieved by virtue of the fact that during the exposure of the corresponding holographic element it is not a plane wave that is used as reference light beam, as explained with reference to FIG. 1, but a spherical wave, while a plane wave is used as object light beam like in the exemplary embodiments of FIGS. 1 and 2.

Such a collimating function may be implemented not only in reflection, but also in transmission, i.e. in the exemplary embodiment of FIG. 1.

In the exemplary embodiments of FIGS. 1 to 3, the first light beam 18 from the first light source 10 and the second light beam 19 from the second light source 12 are each diffracted by the respective holographic element 13, 23, 33, while the second light beam 19 from the second light source 11 passes through the respective holographic element 13, 23, 33. In the exemplary embodiments shown, the second light source 11 emits in the green wavelength range. This may be advantageous since the diffraction of the first light beam 18 and of the third light beam 110 by the respective holographic element leads to losses and, as explained hereinbefore, a maximum intensity of the green light beam is required in some applications on account of the sensitivity of the human eye. However, depending on the performance of the light sources, a light beam from a different wavelength range may also be selected to pass through the respective holographic element while two other light beams are diffracted.

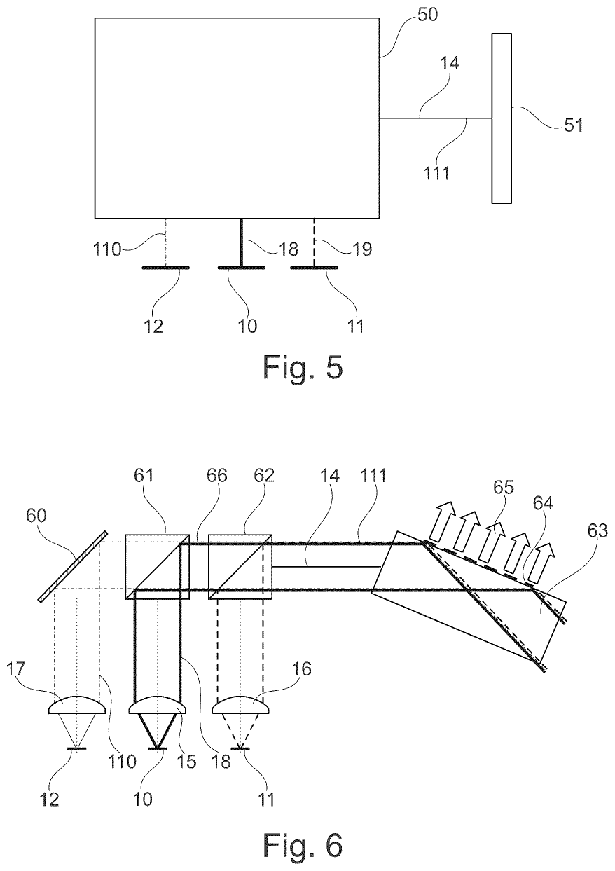

In other exemplary embodiments, the light beams 18, 19, 110 from all three light sources 10, 11, 12 may be diffracted by an appropriate holographic element. Such an exemplary embodiment is shown in FIG. 4. FIG. 4 shows a perspective view. For simplification, the light beams are shown only as individual lines in FIG. 4 and in the following FIG. 5, but extended light beams are also found here, like in the previous figures. In this case, a holographic element 43 is formed as a reflection hologram, which diffracts the light beams 18, 19, 110 from all three light sources 10, 11 and 12 into the direction 14 to create the illumination light beam 111, here in reflection. An embodiment as a transmission hologram is also possible. Moreover, the holographic element 43 may have a collimating effect as explained with reference to FIG. 3, or, for example, corresponding optics units as in FIGS. 1 and 2 may be provided for the light sources 10, 11 and 12.

Such devices for combining beams may be used, for example, for illuminating white image holograms. FIG. 5 shows a schematic diagram of a system according to one exemplary embodiment.

The system of FIG. 5 comprises the first light source 10, which emits a first light beam 18 in the red wavelength range, the second light source 11, which emits a second light beam 19 in the green wavelength range, and the third light source 12, which emits the third light beam 110 in the blue wavelength range. The first light beam 18, the second light beam 19 and the third light beam 110 are supplied to a device 50 for combining beams, which creates the common illumination light beam 111 in the direction 14 from these light beams. In this context, the arrangement of the light sources 10, 11 or 12 may be adapted to the type of device 50 for combining beams. For example, the device 50 for combining beams may be embodied as explained with reference to FIGS. 1 to 4. In this case, the light sources 10, 11 and 12 may then also be arranged as discussed with reference to FIGS. 1 to 4.

The device 50 for combining beams then creates the illumination light beam 111 in the direction 14. In the system of FIG. 5, the illumination light beam 111 is then used to illuminate a white image hologram 51. The white image hologram 51 may then create a white or coloured image in response to the illumination light beam. In this case, a common wavefront is present in the illumination light beam 111 as a result of the device 50 for combining beams, and so the problems of the prior art set forth hereinbefore, such as colour fringes, do not occur or are at least mitigated.

In addition to the devices for combining beams discussed with reference to FIGS. 1 to 4, which use a holographic element, other devices for combining beams may also be used in a system such as the system of FIG. 5. Various examples of this are explained hereinbelow with reference to FIGS. 6 to 8.

FIG. 6 shows an exemplary embodiment in which a device for combining beams is realized by a first beam splitter 61 and a second beam splitter 62. The beam splitters 61, 62 may be realized in a manner known per se, for example by means of semi-transparent mirrors.

The first beam splitter 61 receives the first light beam 18 and the third light beam 110 and combines them to form an intermediate light beam 66. In this context, the third light beam 110 is supplied via a mirror 60 in the illustrated exemplary embodiment. Instead of the mirror 60 or another beam-deflecting element, the third light source 12 and the third optics unit 17 may also be arranged in such a way, i.e. on the left-hand side in the illustration of FIG. 6, that the first beam splitter 61 receives the first light beam 18 and the third light beam 110 from the two mutually perpendicular directions as shown, even without beam deflection. Conversely, further devices for deflecting beams may be provided in the system of FIG. 6 or in other illustrated systems and devices should this be required by a desired or necessary spatial arrangement of the respective components.

The intermediate light beam 66 and the second light beam 19, which is emitted by the second light source 11, are supplied to the second beam splitter and are combined by the latter to form the illumination light beam 111 in the direction 14. In the system of FIG. 6, the illumination light beam 111 serves to illuminate an edge-lit hologram with a carrier 63 and the actual white image hologram 64 arranged on the carrier. In this case, “edge-lit” means that the light is input coupled into the carrier 63 via a lateral edge as shown, and said then illuminates the white image hologram 64 at an angle greater than the angle of the total-internal reflection in order to then create a corresponding image as indicated by arrows 65.

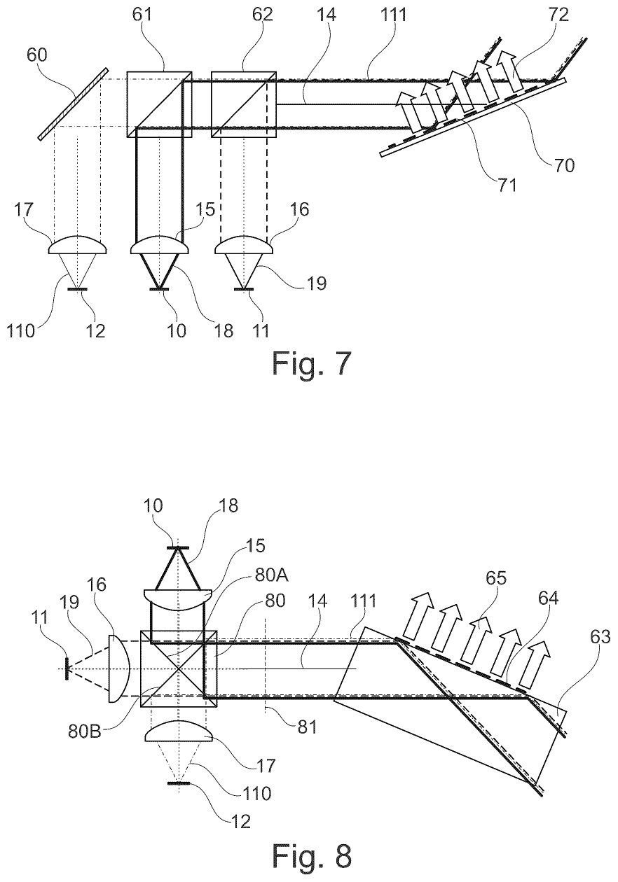

FIG. 7 shows another system, which substantially corresponds to the system of FIG. 6. Instead of the edge-lit hologram, a (free-beam) reflection hologram 71 situated on a carrier 70 and illuminated by the illumination light beam is provided in this case. Thus, different types of white image holograms can be illuminated using the various devices for combining beams shown.

Beam splitters such as the beam splitters 61, 62 have losses, i.e. a portion of the light beams is lost in the beam splitters. Therefore, as regards the illumination of white image holograms, it is advantageous to only input couple the second light beam 19 from the second light source 11 into the second beam splitter 62, since it thus passes through one beam splitter only and has lower losses. As explained above, the illumination of white image holograms requires the greatest intensity in the green wavelength range, and so small losses in this respect are particularly desirable.

In addition to the depicted edge-lit hologram of FIG. 6 and the reflection hologram of FIG. 7, other types of holograms may also be used, for example transmission holograms.

FIG. 8 shows a further option for the realization of a device for combining beams. In this case, what is known as an RGB prism with two dichroic mirrors 80A, 80B serves as a device for combining beams; in essence, this means a combination of two beam splitters in a single component. Such an RGB prism 80 is sometimes also referred to as an “X-Cube”. The first light beam 18, the second light beam 19 and the third light beam 110 are supplied to said RGB prism as shown and are combined to form the illumination light beam 111. In the exemplary embodiment of FIG. 8, the edge-lit hologram already referred to in relation to FIG. 6 is illuminated with the illumination light beam; however, other holograms, for example the reflection hologram of FIG. 7, may also be illuminated here.

The use of a polarized illumination light beam may be advantageous, especially when using edge-lit holograms, since the diffraction efficiency of the hologram for s-polarized light is significantly higher than for p-polarized light, in particular for large angles of incidence during the hologram illumination (measured to the perpendicular). For this purpose, the device for combining beams may be configured to polarize, in particular s-polarize, the illumination light beam. For this purpose, a polarizer 81 as shown in FIG. 8, for example, may optionally be provided. In other exemplary embodiments, polarizers for the first, second and third light beams 110 may be provided instead of a polarizer for the illumination light beam. In yet further exemplary embodiments, the mirrors, for example of the beam splitters 61, 62 or the dichroic mirrors 80a, 80b of the RGB prism 80, may have a polarizing effect. For example, polarizers may be provided by dichroic filters or in any other manner. A combination of a linear polarizer and a λ/2 film may also be used to first polarize the light linearly and then rotate the polarization direction by 90° using the λ/2 film in order to bring it into a suitable polarization plane, e.g. for the edge-lit hologram or beam splitter.

As the above exemplary embodiments show, there are various options for providing a suitable device for combining beams serving to illuminate a white image hologram, and different types of white image holograms may be illuminated. The exemplary embodiments shown should therefore not be construed as limiting.

What is claimed is:

1. A device for combining beams, comprising:
a holographic element that is configured to diffract a first light beam, which is from a first wavelength range and is incident on the holographic element from a first direction, and a second light beam, which is from a second wavelength range that differs from the first wavelength range and is incident on the holographic element from a second direction that differs from the first direction, into a common third direction, which differs from the first direction and the second direction.

2. The device according to claim 1, wherein the holographic element is configured to diffract the first light beam and the second light beam into the third direction starting from a first side of the holographic element, wherein the holographic element is furthermore configured to pass through the holographic element a third light beam, which is from a third wavelength range that differs from the first and second wavelength ranges and is incident on a second side of the holographic element opposite the first side of the holographic element in the third direction.

3. The device according to claim 2, wherein the first, second and third wavelength ranges comprise a red wavelength range, a green wavelength range and a blue wavelength range.

4. The device according to claim 3, wherein the third wavelength range is the green wavelength range.

5. The device according to claim 1, wherein the holographic element is furthermore configured to diffract into the common third direction a third light beam, which is from a third wavelength range that differs from the first and second wavelength ranges and is incident on the holographic element from a fourth direction that differs from the first, second and third directions.

6. The device according to claim 5, wherein the first, second and third wavelength ranges comprise a red wavelength range, a green wavelength range and a blue wavelength range.

7. The device according to claim 6, wherein the third wavelength range is the green wavelength range.

8. The device according to claim 1, wherein the holographic element is configured to collimate the first light beam and/or the second light beam.

9. A system, comprising:
a white image hologram,
a first light source configured to emit a first light beam in a red wavelength range,
a second light source configured to emit a second light beam in a green wavelength range,
a third light source configured to emit a third light beam in a blue wavelength range, and
a device for combining beams, which is configured to combine the first light beam, the second light beam and the third light beam to form a common illumination light beam for the white image hologram.

10. The system according to claim 9, wherein the device for combining beams comprises a holographic element that is configured to diffract a first light beam, which is from a first wavelength range and is incident on the holographic element from a first direction, and a second light beam, which is from a second wavelength range that differs from the first wavelength range and is incident on the holographic element from a second direction that differs from the first direction, into a common third direction, which differs from the first direction and the second direction.

11. The system according to claim 10, wherein the holographic element is configured to diffract the first light beam and the second light beam into the third direction starting from a first side of the holographic element, wherein the holographic element is furthermore configured to pass through the holographic element a third light beam, which is from a third wavelength range that differs from the first and second wavelength ranges and is incident on a second side of the holographic element opposite the first side of the holographic element in the third direction, wherein the first, second and third wavelength ranges comprise a red wavelength range, a green wavelength range and a blue wavelength range, wherein the third wavelength range is the green wavelength range.

12. The system according to claim 10, wherein the holographic element is furthermore configured to diffract into the common third direction a third light beam, which is from a third wavelength range that differs from the first and second wavelength ranges and is incident on the holographic element from a fourth direction that differs from the first, second and third directions, wherein the first, second and third wavelength ranges comprise a red wavelength range, a green wavelength range and a blue wavelength range, wherein the third wavelength range is the green wavelength range.

13. The system according to claim 10, wherein the holographic element is configured to collimate the first light beam and/or the second light beam.

14. The system according to claim 9, wherein the device for combining beams comprises an RGB prism with two dichroic mirrors.

15. The system according to claim 9, wherein the device for combining beams comprises:
a first beam splitter configured to combine two light beams from the group consisting of the first light beam, the second light beam and the third light beam in order to form an intermediate light beam, and
a second beam splitter configured to combine the intermediate light beam and the remaining light beam from the group consisting of the first light beam, the second light beam and the third light beam in order to form the illumination light beam.

16. The system according to claim 15, wherein the remaining light beam is the second light beam.

17. The system according to claim 9, wherein the device for combining beams is configured to polarize the illumination light beam.

18. A system, comprising:
a white image hologram,
a first light source configured to emit a first light beam in a red wavelength range,
a second light source configured to emit a second light beam in a green wavelength range,
a third light source configured to emit a third light beam in a blue wavelength range, and
a device for combining beams, which is configured to combine the first light beam, the second light beam and the third light beam to form a common illumination light beam for the white image hologram, wherein the device for combining beams comprises:
a first beam splitter configured to combine two light beams from the group consisting of the first light beam, the second light beam and the third light beam in order to form an intermediate light beam, and
a second beam splitter configured to combine the intermediate light beam and the remaining light beam from the group consisting of the first light beam, the second light beam and the third light beam in order to form the illumination light beam, wherein the remaining light beam is the second light beam.

19. The system according to claim 18, wherein the remaining light beam is the second light beam.
